(19) United States
(12) Patent Application Publication
(10) Pub. No.: US 2006/0280187 A1
(43) Pub. Date: Dec. 14, 2006

(54) Communication Method and Radio Communication Terminal

(75) Inventors: Masaru FUKUSHIMA, Machida-shi (JP); Hiroyuki HIDAKA, Kawasaki-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/422,870

(22) Filed: Jun. 7, 2006

(30) Foreign Application Priority Data
Jun. 9, 2005 (JP) 2005-169297

(51) Int. Cl. H04L 12/56

(52) U.S. Cl. 370/395.52; 370/493

(57) ABSTRACT

A communication method includes steps of: transmitting a message which requests to register to a call control server from a calling terminal to a called terminal; registering the called terminal to the call control server in response to the message received; and performing a process of starting voice communications using packet communications between the calling terminal and the called terminal which has completed the registering step, through the call control server.

### CROSS REFERENCE TO RELATED APPLICATION

This application is based upon and claims the benefit of priority from the prior Japanese Patent Application No. P2005-169297, filed on Jun. 9, 2005; the entire contents of which are incorporated herein by reference.

### BACKGROUND OF THE INVENTION

1. Field of the Invention

The present invention relates to a communication method and a radio communication terminal capable of performing voice communications using packet communications.

2. Description of the Related Art

There has heretofore been known a technology of realizing VoIP (Voice over IP) communications between general telephone terminals (for example, an ISDN telephone terminal, a PSTN telephone terminal and the like) by use of a SIP (Session Initiation Protocol) server.

However, for example, a conventional VoIP technology using the SIP server in a wired system is based on the assumption that a login process (registration process) for the SIP server is completed by a called terminal.

Specifically, in the VoIP technology, even if the SIP server receives from a calling terminal an INVITE Request (calling request) to a called terminal, the calling terminal cannot start VoIP communications with the called terminal unless the called terminal completes the login process for the SIP server.

Generally, a radio communication terminal, by its nature, cannot always be ready for communications. Thus, it is often the case that the login process for the SIP server is not completed.

Therefore, in the conventional VoIP technology, there is a problem that, even if the SIP server transmits an INVITE Request to a radio communication terminal (the called terminal), it is often the case that the VoIP communications cannot be started between the calling terminal and the radio communication terminal (the called terminal).

### BRIEF SUMMARY OF THE INVENTION

The present invention has been made considering the problems, and its object is to provide a VoIP communication method and a radio communication terminal, which enable VoIP communications to be started between a calling terminal and a called terminal even if the called terminal is not registered with a call control server (SIP server).

A first aspect of the present invention is summarized as a communication method including steps of: transmitting a message which requests to register to a call control server from a calling terminal to a called terminal; registering the called terminal to the call control server in response to the message received; and performing a process of starting voice communications using packet communications between the calling terminal and the called terminal which has completed the registering step, through the call control server.

In the first aspect, the step of performing the process of starting the voice communications can include a step of transmitting a calling request addressed to the called terminal, from the calling terminal to the call control server.

A second aspect of the present invention is summarized as a radio communication terminal capable of performing voice communications using packet communications, including: a selection unit configured to select one message from a plurality of messages which request to register to a call control server, in accordance with an instruction from a user, when the plurality of messages is received; and a called process unit configured to start the voice communications using packet communications with a calling terminal that is a source of the message selected.

A third aspect of the present invention is summarized as a radio communication terminal capable of performing voice communications using packet communications, including: a message reception unit configured to receive a message which requests to register to a call control server; a calling terminal identification information storage unit configured to store identification information on a calling terminal that is a source of the message received; a registration process unit configured to register to the call control server, when the message is received; and a called process unit configured to reject a calling request from the call control server, when identification information on the calling terminal related to the calling request does not coincide with the identification information on the calling terminal stored in the calling terminal identification information storage unit.

A fourth aspect of the present invention is summarized as a radio communication terminal capable of performing voice communications using packet communications, including: a message transmission unit configured to transmit a message which requests to register to a call control server to a called terminal; and a calling request transmission unit configured to transmit to the call control server a calling request addressed to the called terminal, after a predetermined period of time has passed since the transmission of the message.

### BRIEF DESCRIPTION OF THE SEVERAL VIEWS OF THE DRAWINGS

FIG. 1 is a configuration diagram of an entire VoIP communication system according to a first embodiment of the present invention.

FIG. 2 is a functional block diagram of a radio communication terminal according to the first embodiment of the present invention.

FIG. 3 is a view showing an example of a calling terminal selection screen displayed by the radio communication terminal according to the first embodiment of the present invention.

FIG. 4 is a sequence diagram showing a VoIP communication method according to the first embodiment of the present invention.

FIG. 5 is a sequence diagram showing the VoIP communication method according to the first embodiment of the present invention.

FIG. 6 is a sequence diagram showing a VoIP communication method according to a second embodiment of the present invention.

### DETAILED DESCRIPTION OF THE INVENTION

### VoIP Communication System According to First Embodiment of Present Invention

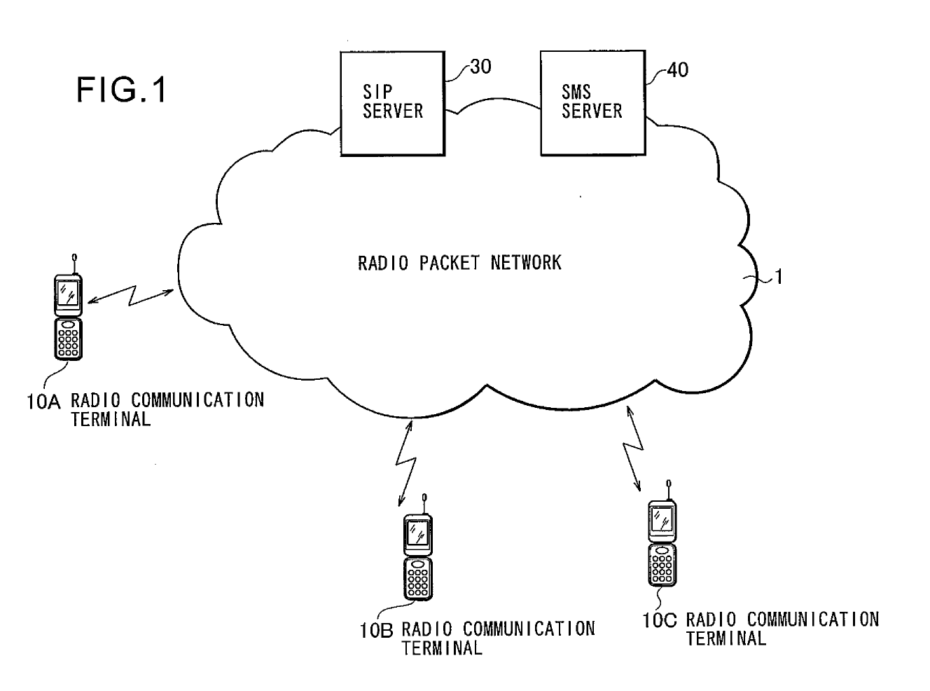

With reference to FIGS. 1 to 3, a description will be given of a configuration of a VoIP communication system according to a first embodiment of the present invention.

In the present specification, a description will be given of an example where VoIP communications are employed as a representative of voice communications using packet communications.

However, the voice communications using packet communications are not limited to the VoIP communications, but include general voice communications performed through a packet network (for example, an IP network).

Moreover, the voice communications using packet communications also include those configured by combining the voice communications and other kinds of communications, such as TV telephone communications and teleconference communications.

As shown in FIG. 1, the VoIP communication system according to this embodiment includes a SIP server 30 and an SMS (Short Message Service) server 40.

Moreover, in this embodiment, radio communication terminals 10A to 10C are configured to be connected to the SIP server 30 and the SMS server 40 through a radio packet network 1.

The SIP server 30 is a call control server configured to perform call control concerning the VoIP communications based on SIP procedures.

To be more specific, the SIP server 30 is configured to manage IP addresses, telephone numbers and the, like of communication terminals (for example, the radio communication terminals 10A to 10C), registration process of which is completed.

The SMS server 40 is a message service providing server configured to provide a message service (short message service).

The radio communication terminals 10A to 10C can perform the VoIP communications with the other communication terminals through the radio packet network 1.

Note that the radio communication terminals 10A to 10C basically have the same configuration. Thus, the configuration of each of the radio communication terminals 10A to 10C will be described below by making a radio communication terminal 10 the representative of the terminals.

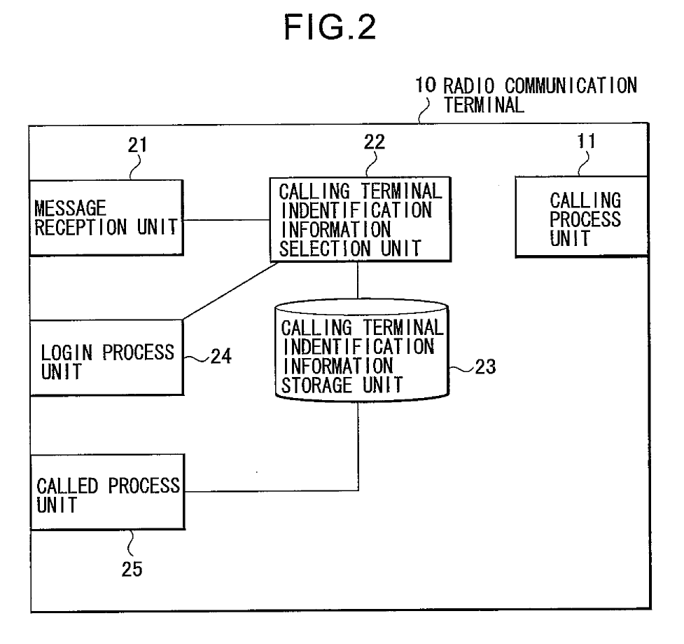

As shown in FIG. 2, the radio communication terminal 10 includes a calling process unit 11, a message reception unit 21, a calling terminal identification information selection unit 22, a calling terminal identification information storage unit 23, a login process unit 24, and a called process unit 25.

The calling process unit 11 is configured to establish sessions with a called terminal, by performing a calling process to the called terminal according to SIP procedures in response to an instruction from a user.

Specifically, the calling process unit 11 is configured to transmit a message (SMS Push) using a Push technology in the short message service to a called terminal #C. In the specification, the message is configured to request to register to a call control server.

Moreover, to be more specific, the calling process unit 11 is configured to transmit the above-described message (SMS Push) to the called terminal; thereafter to perform a login process (registration process) for the SIP server 30 according to the SIP procedures; and to transmit a calling request (INVITE Request) to the SIP server 30 after a lapse of a predetermined period of time. The predetermined period is controlled by a timer or the like, which is provided in the radio communication terminal 10.

The message reception unit 21 is configured to receive a message (SMS Push) which is transmitted by a calling terminal.

The calling terminal identification information selection unit 22 is configured to select one message (SMS Push), when receiving a plurality of messages (SMS Push), from the plurality of messages (SMS Push) according to an instruction from the user.

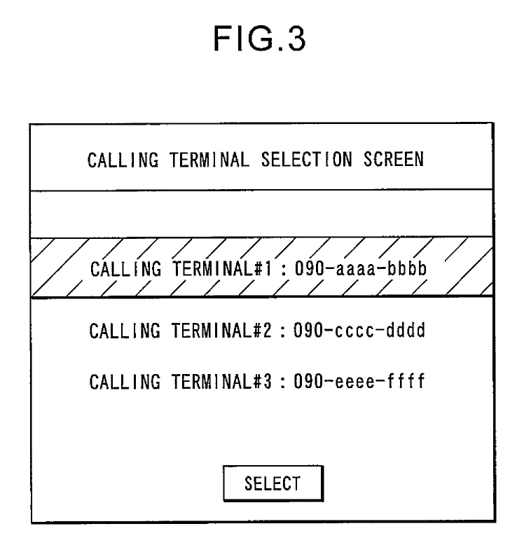

For example, the calling terminal identification information selection unit 22 displays a calling terminal selection screen as shown in FIG. 3, when receiving a plurality of messages (SMS Push).

On the calling terminal selection screen, displayed are the telephone numbers of all the calling terminals that are sources of messages (SMS Push) received by the message reception unit 21 within a predetermined period.

Note that, on the calling terminal selection screen, other identification information (user IDs, IP addresses and the like) on calling terminals may be displayed instead of the telephone numbers of the calling terminals.

The calling terminal identification information selection unit 22 is configured to select, as the message (SMS Push) described above, a message (SMS Push) including identification information of the calling terminal selected by the user through the calling terminal selection screen.

The calling terminal identification information selection unit 22 may be configured to automatically select the message (SMS Push) described above, based on conditions (for example, priority and the like) which are previously set by the user.

The calling terminal identification information storage unit 23 is configured to store identification information (for example, a telephone number) on the calling terminal that is the source of the message (SMS Push) selected by the calling terminal identification information selection unit 22.

The calling terminal identification information storage unit 23 may be configured to identification information (for example, telephone numbers) of all the calling terminals that are the sources of the messages (SMS Push) received by the message reception unit 21.

The login process unit 24 is configured to perform a login process (registration process) for the SIP server 30, according to the SIP procedures, upon receipt of a message (SMS Push).

In other words, the login process unit 24 is configured to register the radio communication terminal 10 to the SIP server 30, when a message (SMS Push) is received.

To be more specific, the login process unit 24 is configured to notify the SIP server 30 of the telephone number, the IP address, the user ID and the like of the radio communication terminal by the login process.

The login process unit 24 may be configured to perform a login process (registration process) for the SIP server 30 after a predetermined period of time has passed since receipt of the message (SMS Push).

The called process unit 25 is configured to start VoIP communications with the calling terminal that is the source of the message selected by the calling terminal identification information selection unit 22, according to the SIP procedures, after the login process (registration process) for the SIP server 30 is completed.

Moreover, the called process unit 25 is configured to reject a calling request (INVITE Request) from the SIP server 30, when the calling terminal identification information related to the calling request (INVITE Request) does not coincide with the identification information on the calling terminal stored in the calling terminal identification information storage unit 23.

### VoIP Communication Method According to First Embodiment of Present Invention

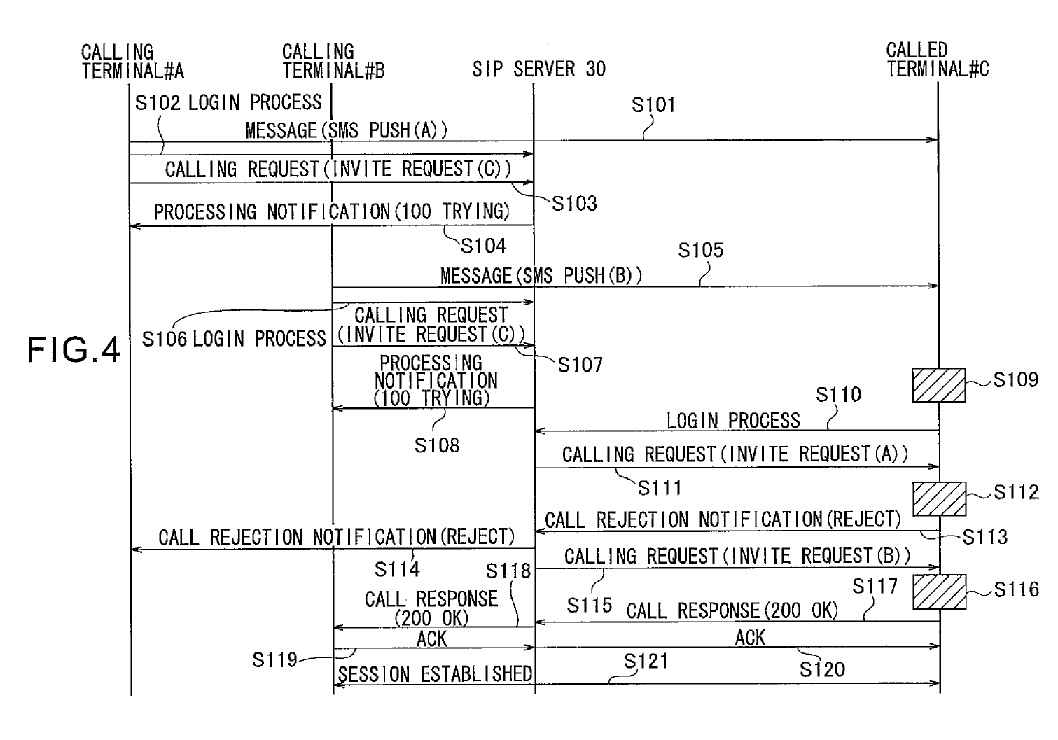

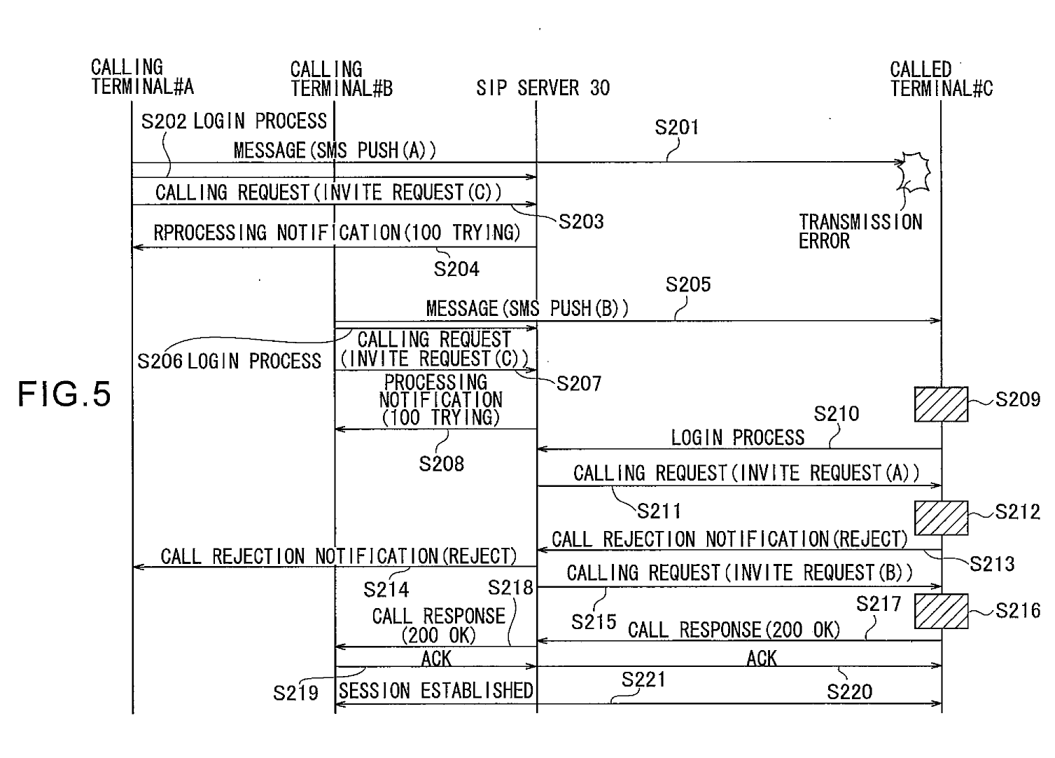

With reference to FIGS. 4 and 5, a VoIP communication method according to the first embodiment of the present invention will be described below.

FIG. 4 shows an example of the case where a called terminal #C starts VoIP communications by selecting a calling terminal #B as a correspomdence of the VoIP communications from among calling terminals #A and #B, each of which transmits a message to the called terminal #C.

As shown in FIG. 4, in Step S101, the calling terminal #A transmits a message (SMS Push (A)) to the called terminal #C without going through the SIP server 30.

In Step S102, the calling terminal #A performs a login process for the SIP server 30.

In Step S103, after a predetermined period has passed since the transmission process of the message (SMS Push (A)) to the called terminal #C, the calling terminal #A transmits to the SIP server 30 a calling request (INVITE Request(C)) addressed to the called terminal #C.

Here, the calling request (INVITE Request(C)) addressed to the called terminal #C includes information indicating the telephone number of the called terminal #C.

In Step S104, the SIP server 30 transmits to the calling terminal #A a processing notification (100 Trying) for notifying that the calling request (INVITE Request(C)) addressed to the called terminal #C is being processed.

In Step S105, the calling terminal #B transmits a message (SMS Push(B)) to the called terminal #C without going through the SIP server 30.

In Step S106, the calling terminal #B performs a login process for the SIP server 30.

In Step S107, after a predetermined period has passed since the transmission processing of the message (SMS Push (B)) to the caalled terminal #C, the calling terminal #B transmits to the SIP server 30 a calling request (INVITE Request(C)) addressed to the called terminal #C.

Here, the calling request (INVITE Request(C)) addressed to the called terminal #C includes information indicating the telephone number of the called terminal #C.

In Step S108, the SIP server 30 transmits to the calling terminal #B a processing notification (100 Trying) for notifying that the calling request (INVITE Request(C)) addressed to the called terminal #C is being processed.

In Step S109, the called terminal #C selects a message including identification information on the calling terminal #B according to an instruction from a user, and stores the selected identification information on the calling terminal #B in the calling terminal identification information storage unit 23.

In Step S110, the called terminal #C performs a login process for the SIP server 30 after a predetermined period has passed since receipt of the message (SMS Push(A)) addressed to the called terminal #C.

In Step S111, the SIP server 30 transmits to the called terminal #C a calling request (INVITE Request(A)) addressed to the called terminal #C, which is generated based on the calling request (INVITE Request(C)) addressed to the called terminal #C, which calling request (INVITE Request(C)) is the first one that is received, and which calling request is from the calling terminal #A.

Here, the calling request (INVITE Request(A)) addressed to the called terminal #C includes identification information on the calling terminal #A, and is transmitted to an IP address of the called terminal #C.

In Step S112, the called terminal #C determines whether or not the identification information of the calling terminal (#A) related to the calling request (INVITE Request(A)) from the SIP server 30, coincides with the identification information of the calling terminal (#B) stored in the calling terminal identification information storage unit 23.

In Step S113, since the two pieces of information described above do not coincide with each other, the called terminal #C transmits to the SIP server 30 a call rejection notification (Reject) for rejecting the calling request (INVITE Request(A)).

In Step S114, the SIP server 30 transmits the call rejection notification (Reject) to the calling terminal #A.

Thereafter, in Step S115, the SIP server 30 transmits to the called terminal #C a calling request (INVITE Request(B)) addressed to the called terminal #C, which is generated based on the calling request (INVITE Request(C)) addressed to the called terminal #C, which calling request (INVITE Request(C)) is the second one that is received, and which calling request is from the calling terminal #B.

Here, the calling request (INVITE Request(B)) addressed to the called terminal #C includes identification information on the calling terminal #B, and is transmitted to the IP address of the called terminal #C.

In Step S116, the called terminal #C determines whether or not the identification information of the calling terminal (#B) related to the invite request (INVITE Request(B)) from the SIP server 30, coincides with the identification information of the calling terminal (#B) stored in the calling terminal identification information storage unit 23.

In Step S117, since the two pieces of information described above coincide with each other, the called terminal #C transmits to the SIP server 30 a call response (200 OK) for accepting the calling request (INVITE Request(B)).

Thereafter, in Step S118, the SIP server 30 transmits the call response (200 OK) to the calling terminal #B.

In Step S119, the calling terminal #B transmits to the SIP server 30 an ACK indicating that the call response (200 OK) is received. Thereafter, in Step S120, the SIP server 30 transmits the ACK to the called terminal #C.

In Step S121, a session between the calling terminal #B and the called terminal #C is established, and VoIP communications are started between the calling terminal #B and the called terminal #C through the session.

Next, with reference to FIG. 5, description will be given of an example of the case where, although the calling terminals #A and #B transmit messages to the called terminal #C, the message transmitted to the called terminal #C from the calling terminal #A does not reach the called terminal #C due to a communication error or the like.

As shown in FIG. 5, in Step S201, the calling terminal #A tries to transmit a message (SMS Push(A)) to the called terminal #C without going through the SIP server 30, but fails.

In this case, the SMS server 40 retransmits the message (SMS Push(A)), of which transmission has failed as described above, by a predetermined number of times.

Since the calling terminal #A is not aware of the failed transmission described above, the calling terminal #A performs a login process for the SIP server 30 in Step S202.

Subsequently, after a predetermined period of time has passed since the transmission process of the message (SMS Push(A)) to the called terminal #C, the calling terminal #A transmits to the SIP server 30 a calling request (INVITE Request(C)) addressed to the called terminal #C in Step S203.

Here, the calling request (INVITE Request(C)) addressed to the called terminal #C includes information indicating the telephone number of the called terminal #C.

Since the SIP server 30 is not aware of the failed transmission described above, either, in Step S204, the SIP server 30 transmits to the calling terminal #A a processing notification (100 Trying) for notifying that the calling request (INVITE Request(C)) addressed to the called terminal #C is being processed.

In Step S205, the calling terminal #B transmits to the called terminal #C a message (SMS Push(B)) addressed to the called terminal #C without going through the SIP server 30.

In Step S206, the calling terminal #B performs a login process for the SIP server 30.

In Step S207, after a predetermined period has passed since the transmission process of the message (SMS Push(B)) addressed to the called terminal #C, the calling terminal #B transmits to the SIP server 30 a calling request (INVITE Request(C)) addressed to the called terminal #C.

Here, the calling request (INVITE Request(C)) addressed to the called terminal #C includes information indicating the telephone number of the called terminal #C.

In Step S208, the SIP server 30 transmits to the calling terminal #B a processing notification (100 Trying) for notifying that the calling request (INVITE Request(C)) addressed to the called terminal #C is being processed.

In Step S209, the called terminal #C stores identification information on the calling terminal #B, which has been successfully received, in the calling terminal identification information storage unit 23.

In Step S210, the called terminal #C performs a login process for the SIP server 30 after a predetermined period has passed since the receipt of the message (SMS Push (B)) addressed to the called terminal #C.

In Step S211, the SIP server 30 transmits to the called terminal #C a calling request (INVITE Request(A)) addressed to the called terminal #C, which is generated based on the calling request (INVITE Request(C)) addressed to the called terminal #C, which calling request (INVITE Request(C)) is the first one that is received, and which calling request is from the calling terminal #A.

Here, the calling request (INVITE Request(A)) addressed to the called terminal #C includes identification information on the calling terminal #A, and is transmitted to the IP address of the called terminal #C.

In Step S212, the called terminal #C determines whether or not the identification information of the calling terminal (#A) related to the calling request (INVITE Request(A)) from the SIP server 30, coincides with the identification information of the calling terminal (#B) stored in the calling terminal identification information storage unit 23.

In Step S213, since the two pieces of information described above do not coincide with each other, in other words, a message including the identification information on the calling terminal #A is not received, the called terminal #C transmits to the SIP server 30 a call rejection notification (Reject) for rejecting the calling request (INVITE Request(A)).

In Step S214, the SIP server 30 transmits the call rejection notification (Reject) to the calling terminal #A.

Thereafter, in Step S215, the SIP server 30 transmits to the called terminal #C a calling request (INVITE Request(B)) addressed to the called terminal #C, which is generated based on the calling request (INVITE Request(C)) addressed to the called terminal #C, which calling request (INVITE Request(C)) is the second one that is received, and which is from the calling terminal #B.

Here, the calling request (INVITE Request(B)) addressed to the called terminal #C includes the identification information on the calling terminal #B, and is transmitted to the IP address of the called terminal #C.

In Step S216, the called terminal #C determines whether or not the identification information of the calling terminal (#B) related to the calling request (INVITE Request(B)) from the SIP server 30 coincides with the identification information of the calling terminal (#B) stored in the calling terminal identification information storage unit 23.

In Step S217, since the two pieces of information described above coincide with each other, in other words, a message including the identification information on the calling terminal #B is received, the called terminal #C transmits to the SIP server 30 a call response (200 OK) for accepting the calling request (INVITE Request(B)).

Thereafter, in Step S218, the SIP server 30 transmits the call response (200 OK) to the calling terminal #B.

In Step S219, the calling terminal #B transmits to the SIP server 30 an ACK indicating that the call response (200 OK) is received. Thereafter, in Step S220, the SIP server 30 transmits the ACK to the called terminal #C.

In Step S221, a session between the calling terminal #B and the called terminal #C is established, and VoIP communications are started between the calling terminal #B and the called terminal #C through the session.

### Operations and Effects of VoIP Communication System and VoIP Communication Method According to First Embodiment of Present Invention

According to the VoIP communication system and the VoIP communication method according to the first embodiment of the present invention, a message can encourage the called terminal #C to perform a login process for the SIP server 30.

Thus, even if the login process for the SIP server 30 is not completed by the called terminal #C, it is possible to start VoIP communications with the called terminal #C as long as the called terminal #C is in a state of being able to receive the message (for example, in a power-on state).

According to the VoIP communication system and the VoIP communication method according to the first embodiment of the present invention, after the called terminal #C is registered with the SIP server 30 by the message, as described above, the VoIP communications can be started by use of a method similar to the conventional VoIP communication method. Thus, it is possible to utilize resources of the conventional VoIP communication system.

According to the VoIP communication system and the VoIP communication method according to the first embodiment of the present invention, from sources of plural messages concurrently received, the user of the called terminal #C can freely select a calling terminal to be the correspondence with whom the user performs the VoIP communications.

According to the VoIP communication system and the VoIP communication method according to the first embodiment of the present invention, in the case where a message does not reach the called terminal #C due to a communication error or the like, the called terminal #C can resolve an inconsistent situation that the source of the message and the source of the calling request do not coincide with each other.

According to the VoIP communication system and the VoIP communication method according to the first embodiment of the present invention, upon receipt of a plurality of messages, the called terminal #C can automatically reject the calling requests from the transmission terminals that are the sources of the messages not selected by the called terminal #C.

According to the VoIP communication system and the VoIP communication method according to the first embodiment of the present invention, the calling terminal is configured to perform the login process for the SIP server 30 after activating the called terminal by transmitting the message (SMS Push).

Thus, the login process by the calling terminal and the login processing by the called terminal are performed in parallel. Therefore, the time required to start the VoIP communications can be shortened.

### Second Embodiment of Present Invention

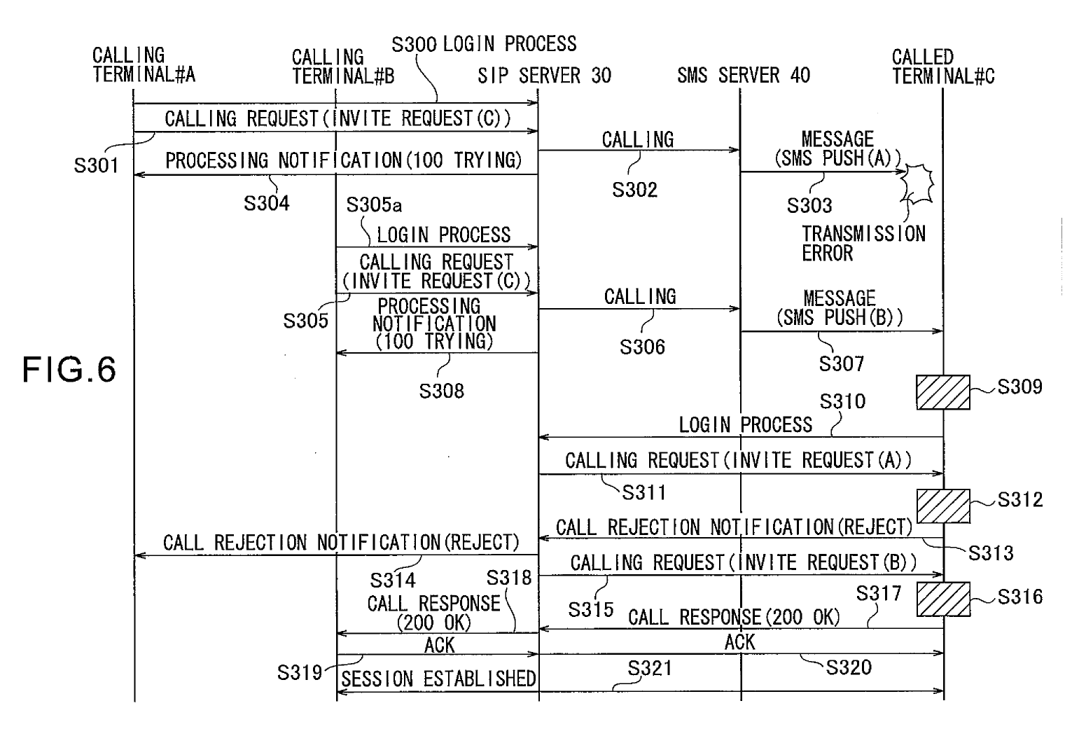

With reference to FIG. 6, a description will be given of a VoIP communication system and a VoIP communication method according to a second embodiment of the present invention.

Differences in the VoIP communication system and the VoIP communication method between the first and second embodiments of the present invention will be mainly described below.

A calling process unit 11 in a radio communication terminal 10 according to this embodiment is configured to transmit to a SIP server 30 a calling request (INVITE Request) based on SIP procedures, as a calling request to a called terminal, according to an instruction from the user.

With reference to FIG. 6, the VoIP communication method according to the second embodiment of the present invention will be described below.

With reference to FIG. 6, a description will be given of an example of the case where, although calling terminals #A and #B transmit calling requests addressed to a called terminal #C, a message addressed to the called terminal #C from the calling terminal #A does not reach the called terminal #C due to a communication error or the like.

As shown in FIG. 6, in Step S300, the calling terminal #A performs a login process for the SIP server 30.

In Step S301, the calling terminal #A transmits to the SIP server 30 a calling request (INVITE Request(C)) addressed to the called terminal #C.

Here, the calling request (INVITE Request(C)) addressed to the called terminal #C includes information indicating the telephone number of the called terminal #C.

In Step S302, the SIP server 30 calls a SMS server 40 and notifies that the SIP server 30 has received the above-described calling request (INVITE Request(C)) addressed to the called terminal #C from the calling terminal #A.

In Step S303, the SMS server 40 generates a message (SMS Push (A)) addressed to the called terminal #C in response to the notification from the SIP server 30.

Thereafter, the SMS server 40 tries to transmit to the called terminal #C the message (SMS Push(A)) addressed to the called terminal #C, but fails.

Since the SIP server 30 is not aware of the failed transmission described above, in Step S304, the SIP server 30 transmits to the calling terminal #A a processing notification (100 Trying) for notifying that the calling request (INVITE Request(C)) addressed to the called terminal #C is being processed.

In Step S305a, the calling terminal #B performs a login process for the SIP server 30.

In Step S305, the calling terminal #B transmits to the SIP server 30 a calling request (INVITE Request(C)) addressed to the called terminal #C.

Here, the calling request (INVITE Request(C)) addressed to the called terminal #C includes the information indicating the telephone number of the called terminal #C.

In Step S306, the SIP server 30 calls the SMS server 40 and notifies that the SIP server 30 has received the above-described calling request (INVITE Request(C)) addressed to the called terminal #C from the calling terminal #B.

In Step S307, the SMS server 40 generates a message (SMS Push (B)) addressed to the called terminal #C in response to the notification from the SIP server 30, and transmits to the called terminal #C the message (SMS Push(B)) addressed to the called terminal #C.

In Step S308, the SIP server 30 transmits to the calling terminal #B a processing notification (100 Trying) for notifying that the calling request (INVITE Request(C)) addressed to the called terminal #C is being processed.

In Step S309, the called terminal #C stores identification information on the calling terminal #B, which has been successfully received, in the calling terminal identification information storage unit 23.

Operations in Steps S310 to S321 are the same as those in Steps S210 to S221 in FIG. 5.

Note that, as described in the first and second embodiments, the present invention is applicable not only to the case where there is one called terminal but also to the case where there exist a plurality of called terminals (for example, the case of teleconference communications).

Moreover, in the first and second embodiments described above, the description was given of the case where the SIP is used as a communication protocol. However, the present invention is not limited to the case described above, but is also applicable to the case where any protocol is used as long as the protocol can realize the operations shown in FIGS. 4 to 6.

The present invention can provide a VoIP communication method and a radio communication terminal, which enable VoIP communications to be started between a calling terminal and a called terminal even if the called terminal is not registered with a call control server (SIP server).

Additional advantages and modifications will readily occur to those skilled in the art. Therefore, the invention in its broader aspects is not limited to the specific details and the representative embodiments shown and described herein. Accordingly, various modifications may be made without departing from the scope of the general inventive concept as defined by the appended claims and their equivalents.

What is claimed is:

1. A communication method comprising steps of:
transmitting a message which requests to register to a call control server from a calling terminal to a called terminal;
registering the called terminal to the call control server in response to the message received; and
performing a process of starting voice communications using packet communications between the calling terminal and the called terminal which has completed the registering step, through the call control server.

2. The communication method according to claim 1, wherein
the step of performing the process of starting the voice communications comprises a step of transmitting a calling request addressed to the called terminal, from the calling terminal to the call control server.

3. A radio communication terminal capable of performing voice communications using packet communications, comprising:
a selection unit configured to select one message from a plurality of messages which request to register to a call control server, in accordance with an instruction from a user, when the plurality of messages is received; and
a called process unit configured to start the voice communications using packet communications with a calling terminal that is a source of the message selected.

4. A radio communication terminal capable of performing voice communications using packet communications, comprising:
a message reception unit configured to receive a message which requests to register to a call control server;
a calling terminal identification information storage unit configured to store identification information on a calling terminal that is a source of the message received;
a registration process unit configured to register to the call control server, when the message is received; and
a called process unit configured to reject a calling request from the call control server, when identification information on the calling terminal related to the calling request does not coincide with the identification information on the calling terminal stored in the calling terminal identification information storage unit.

5. A radio communication terminal capable of performing voice communications using packet communications, comprising:
a message transmission unit configured to transmit a message which requests to register to a call control server to a called terminal; and
a calling request transmission unit configured to transmit to the call control server a calling request addressed to the called terminal, after a predetermined period of time has passed since the transmission of the message.
